(19) United States
(12) Patent Application Publication
(10) Pub. No.: US 2016/0212591 A1
(43) Pub. Date: Jul. 21, 2016

(54) EXHIBITION GUIDE APPARATUS, EXHIBITION DISPLAY APPARATUS, MOBILE TERMINAL, AND EXHIBITION GUIDE METHOD

(71) Applicant: ELECTRONICS AND TELECOMMUNICATIONS RESEARCH INSTITUTE, Daejeon-si (KR)

(72) Inventors: Sung Hee KIM, Daejeon-si (KR); Hyung Keuk LEE, Seoul (KR); Hyun Woo LEE, Seoul (KR)

(21) Appl. No.: 14/726,902

(22) Filed: Jun. 1, 2015

(30) Foreign Application Priority Data
Jan. 21, 2015 (KR) 10-2015-0010215

(51) Int. Cl. H04W 4/04; H04W 4/02

(52) U.S. Cl. CPC H04W 4/043; H04W 4/021

(57) ABSTRACT

An exhibition guide apparatus, an exhibition display apparatus, and a mobile terminal. The exhibition guide apparatus, which communicates with the exhibition display apparatus and the mobile terminal, includes: an exhibition hall information manager configured to store and manage space information on an exhibition hall and location information on exhibition objects displayed at the exhibition hall; a visitor information manager configured to store and manage visitor information that includes one or more of identification information, visitor avatar information, visitor location information, and exhibition experience history information; a viewing guide information generator configured to generate viewing guide information that includes one or more of exhibition experience history information, viewing status information on currently viewed exhibition objects, and viewing guide information on exhibition objects to be viewed in the future; and a transmitter configured to transmit the viewing guide information to either or both of the mobile terminal and the exhibition display apparatus.

### CROSS-REFERENCE TO RELATED APPLICATION(S)

This application claims priority from Korean Patent Application No. 10-2015-0010215, filed on Jan. 21, 2015, in the Korean Intellectual Property Office, the entire disclosure of which is incorporated herein by reference for all purposes.

### BACKGROUND

1. Field

The following description generally relates to an exhibition guide system, and more particularly to an exhibition guide apparatus, an exhibition display apparatus, and a mobile terminal.

2. Description of the Related Art

Information on exhibition objects displayed at a museum or at an exhibition is provided with simple descriptions of pictures or texts attached on the exhibition wall, such that the information or knowledge may not be provided in depth. In order to solve the drawback, a ubiquitous computing system has been developed to provide exhibition visitors with various multimedia services. Examples of the ubiquitous computing system include a touchscreen kiosk, a cyber guide system using the Internet, a voice guide device using MP3 files, a PDA-based guide system, and the like.

Specifically, when visitors enter the exhibition hall, they may buy their entrance tickets by touching posters on the wall of the exhibition, pamphlets or kiosks with their mobile terminals. Alternatively, when visitors enter the exhibition hall, a welcome message or a guide message may be shown through kiosks, or exhibition guide maps may be provided to visitors' mobile terminal. In another example, by using mobile terminals and the like, visitors may see information on exhibition objects through QR codes or RFID tags that include the information on exhibition objects. That is, in the current exhibition guide, timeliness (nowness) of accessible exhibition information is an important factor.

### SUMMARY

Provided is an apparatus and method that may enable visitors to see exhibition objects efficiently by considering accessibility to information regarding exhibition objects.

Provided is an apparatus and method for providing viewing guide information customized for each visitor by combining a visitor's information on the past, present, and future visits.

Provided is an apparatus and method that may enable visitors to see exhibition objects according to their intentions.

In one general aspect, there is provided an exhibition guide apparatus that communicates with an exhibition display apparatus and a mobile terminal, the exhibition guide apparatus including: an exhibition hall information manager configured to store and manage space information on an exhibition hall and location information on exhibition objects displayed at the exhibition hall; a visitor information manager configured to store and manage visitor information that includes one or more of identification information, visitor avatar information, visitor location information, and exhibition experience history information; a viewing guide information generator configured to generate viewing guide information that includes one or more of exhibition experience history information, viewing status information on currently viewed exhibition objects, and viewing guide information on exhibition objects to be viewed in the future, by using the space information on the exhibition hall and the location information on exhibition objects, and the visitor information; and a transmitter configured to transmit the viewing guide information to either or both of the mobile terminal and the exhibition display apparatus.

The visitor information manager may store and manage visitor information received from the mobile terminal.

The viewing guide information generator may generate the viewing guide information by using basic viewing guide information that includes one or more of the space information on the exhibition hall, the location information on exhibition objects, the visitor information, viewing time of a specific exhibition object, information on whether details about the specific exhibition object have been viewed, information on currently viewed contents and information on contents to be viewed in the future based on the information on whether details about the specific exhibition object have been viewed.

The exhibition guide apparatus may further include an exhibition experience lifelog information manager configured to store and manage exhibition experience lifelog information that indicates whether details about the specific exhibition object have been viewed; and the transmitter may transmit the exhibition experience lifelog information to either or both of the mobile terminal and the exhibition display apparatus.

The exhibition experience lifelog information manager may store and manage the exhibition experience lifelog information that indicates whether a visitor has seen details about exhibition objects based on a viewing result of exhibition objects, by comparing with the viewing guide information.

In another general aspect, there is provided an exhibition display apparatus that communicates with an exhibition guide apparatus and a mobile terminal, the exhibition display apparatus including: an exhibition hall display component configured to display space information on an exhibition hall that is received from the exhibition guide apparatus, location information on exhibition objects displayed at the exhibition hall, visitor information, viewing guide information, and exhibition experience lifelog information; and a visitor avatar display component configured to display an avatar of a visitor in the exhibition hall displayed by the exhibition hall display component according to avatar control information received from the mobile terminal.

The exhibition hall display component may display a virtual exhibition hall generated by using the space information on the exhibition hall and the location information on exhibition objects displayed at the exhibition hall.

The exhibition hall display component may display viewing status information on the real exhibition that is received from the exhibition guide apparatus, or viewing displays status information on the real exhibition hall that is generated by using images acquired from an image capturing apparatus.

The exhibition hall display component may display detailed information on an exhibition object that is being currently viewed according to viewing order information received from the exhibition guide apparatus or the mobile terminal.

The exhibition display apparatus may further include: a detailed exhibition object information display component configured to display detailed information on exhibition objects according to the avatar control information; and a detailed exhibition object information transmitter configured to transmit the detailed exhibition object information to the mobile terminal.

The detailed exhibition object information display component may display detailed information on a specific exhibition object by comparing location information of the specific exhibition object displayed by the exhibition hall display component with location information of a visitor avatar controlled by the avatar control information.

In yet another general aspect, there is provided a mobile terminal that communicates with an exhibition guide apparatus and an exhibition display apparatus, the mobile terminal including: a location information generator configured to generate location information of the mobile terminal by measuring a current location of the mobile terminal; a visitor information generator configured to generate visitor information that includes one or more of identification information, visitor avatar information, visitor location information, and exhibition experience history information; a viewing order information generator configured to generate viewing order information according to plans for viewing exhibition objects selected by a visitor based on viewing guide information that includes one or more of exhibition experience history information, viewing status information of currently viewed exhibition objects, and viewing guide information of exhibition objects to be viewed in the future; a transmitter configured to transmit the location information of the mobile terminal, the visitor information, and the viewing order information to either or both of the exhibition guide apparatus and the exhibition display apparatus; and a display configured to display, on a screen of the mobile terminal, the visitor information and the viewing guide information acquired through a user interface of the mobile terminal or from the exhibition guide apparatus.

The location information generator may measure a location of the mobile terminal by using a signal received from a wireless signal generator.

The location information generator may generate location information of a visitor by measuring a location of the visitor that carries the mobile terminal; and the transmitter may transmit the location information of the visitor, the visitor information, and the viewing order information to either or both of the exhibition guide apparatus and the exhibition display apparatus.

The mobile terminal may further include an avatar control information generator configured to generate avatar control information to control avatar information of the visitor displayed by the exhibition display apparatus; and the transmitter may transmit the avatar control information to the exhibition display apparatus.

The mobile terminal may further include a path tracking display component, which in response to change in a location of the mobile terminal, is configured to display avatar tracking information that includes a path of movement from a location before the change to a location after the change.

### BRIEF DESCRIPTION OF THE DRAWINGS

FIG. 1 is a block diagram illustrating an entire structure of an exhibition guide system according to an exemplary embodiment.

FIG. 2 is a block diagram schematically illustrating an exhibition guide apparatus according to an exemplary embodiment.

FIG. 3 is a block diagram schematically illustrating an exhibition display apparatus according to an exemplary embodiment.

FIG. 4 is a block diagram schematically illustrating a mobile terminal according to an exemplary embodiment.

FIG. 5 is a flowchart illustrating an exhibition guide method of an exhibition guide apparatus according to an exemplary embodiment.

FIG. 6 is a flowchart illustrating an exhibition guide method of an exhibition guide apparatus according to another exemplary embodiment.

FIG. 7 is a flowchart illustrating an exhibition guide method in an exhibition guide system according to an exemplary embodiment.

FIG. 8 is a flowchart illustrating an exhibition guide method in an exhibition guide system according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The terms used herein are defined in consideration of the functions of elements in the present invention, and can be changed according to the intentions or the customs of a user and an operator. Accordingly, the terms used in the following embodiments conform to the definitions described specifically in the present disclosure, and if there are no specific definitions, the terms should be interpreted as having the same meaning as commonly understood by one of ordinary skill in the art to which this invention belongs.

“Exhibition space” refers to general museums established in modern times, specialized museums, such as a museum of art, a museum of science, and the like, which have been established after modern times and derived from the general museums, expos, theme parks derived from the expos, exhibition conventions, and the like. People visit and experience the exhibition space for purposes of information, education, entertainment, and the like, which may be called spatial practices. The exhibition space is a culture area where two spatial practices overlap, in which one spatial practice of a host that supervises the exhibition creates the exhibition space, and the other spatial practice of visitors enables the exhibition space to be used according to various purposes.

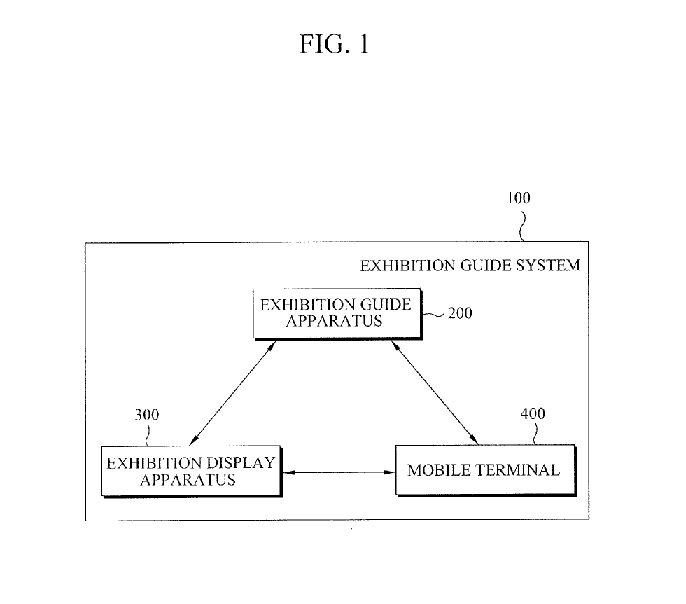

FIG. 1 is a block diagram illustrating an entire structure of an exhibition guide system according to an exemplary embodiment.

Referring to FIG. 1, the exhibition guide system 100 includes an exhibition guide apparatus 200, an exhibition display apparatus 300, and a mobile terminal 400.

The exhibition guide system 100 may be installed at various exhibition venues, such as museums, art museums, folk museums, expos, historic sites, palaces, and the like. For example, the exhibition guide system 100 may be installed at medium and large indoor exhibitions, such as museums and convention halls, outdoor exhibition venues, such as theme parks and expos, Jeonju traditional Korean villages, palaces, and the like, to be used as guide systems. Further, the exhibition guide system 100 may be used as an exhibition guide system for virtual space tour by restoring destructed historic sites, such as sites of Hwangnyongsa temple or Mireuksa Temple.

The exhibition guide apparatus 200 may acquire information on a visitor from the mobile terminal 400 and the like carried by the visitor, and may generate viewing guide information for each visitor, to provide the generated information to the exhibition display apparatus 300 and/or the mobile terminal 400. Further, the exhibition guide apparatus 200 may store information required to generate the exhibition guide, and may manage the stored information by updating, deleting, or the like.

The exhibition guide apparatus 200 may include an exhibition information database in which information necessary for system operations is stored, and middle ware that connects and relays the database with an external device.

The exhibition guide apparatus 200 may be connected with the exhibition display apparatus 300 through a wired or a wireless network. The exhibition guide apparatus 200 may be connected with the mobile terminal 400 through a wireless network. In one exemplary embodiment, the exhibition guide apparatus 200 may provide identical information to the exhibition display apparatus 30 and the mobile terminal 400.

The exhibition display apparatus 300 displays information received from the exhibition guide apparatus 200. Further, the exhibition display apparatus 300 displays avatars of visitors according to avatar control information received from the mobile terminal 400.

The exhibition display apparatus 300 may be installed in indoor spaces, including exhibition halls, which have the purpose of viewing, appreciating, and evaluating exhibition objects. For example, the exhibition display apparatus 300 may be a kiosk, a Digital Signage, a telescreen, or a combination of them.

The exhibition display apparatus 300 may be connected with the exhibition guide apparatus 200 through a wired or wireless network. The exhibition display apparatus 300 may be connected with the mobile terminal 400 through a wireless network. For example, the wireless network may be a mobile telecommunication network, a wireless Internet (WiFi), or the like.

The mobile terminal 400 may generate location information, visitor information, and viewing order information on exhibition objects, and transmit the generated information to either or both of the exhibition guide apparatus 200 and the exhibition display apparatus 300. Further, the mobile terminal 400 may display visitor information and viewing guide information.

The mobile terminal (400) may transmit and receive information to/from the exhibition guide apparatus 200 and the exhibition display apparatus 300 through a wireless network. For example, the wireless network may be a mobile telecommunication network, a wireless Internet (WiFi), or the like.

The mobile terminal 400 may be any one mobile terminal among a personal mobile communication services terminal, a Personal Digital Assistant (PDA), a Smartphone, a tablet, a laptop computer, and a wireless Local Area Network (LAN) mobile terminal, a smart glasses, and the like, which is portable and performs various functions.

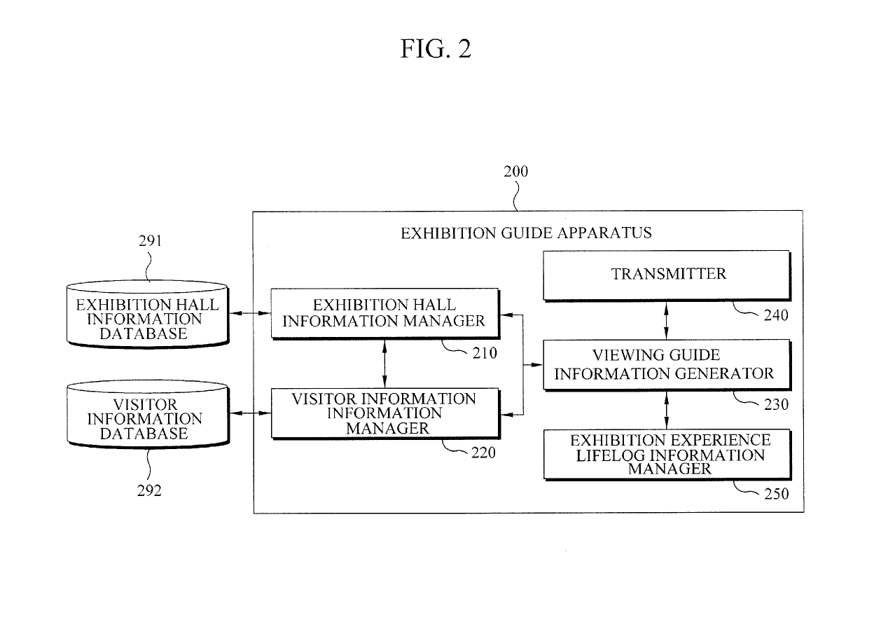

FIG. 2 is a block diagram schematically illustrating an exhibition guide apparatus according to an exemplary embodiment.

Referring to FIG. 2, the exhibition guide apparatus 200 includes an exhibition hall information manager 210, a visitor information manager 220, a viewing guide information generator 230, and a transmitter 240. In the exemplary embodiment, the exhibition guide apparatus 200 may further include an exhibition experience lifelog information manager 250. Further, the exhibition guide apparatus 200 is merely illustrative, and the exhibition guide apparatus 200 may include only some of the modules illustrated in FIG. 2, and/or may further include other modules necessary for its operation. For example, the exhibition guide apparatus 200 may further include an exhibition status image generator that generates images about exhibition status by using images acquired from an image capturing apparatus installed at an exhibition hall.

Hereinafter, the exhibition hall information manager 210, the visitor information manager 220, the viewing guide information generator 230, and the transmitter 240 are described as individual elements. However, the exhibition hall information manager 210, the visitor information manager 220, the viewing guide information generator 230, the transmitter 240, and the exhibition experience lifelog information manager 250 may be implemented in a single element, a single physical device, or a single module. For example, the exhibition hall information manager 210, the visitor information manager 220, the viewing guide information generator 230, the transmitter 240, and the exhibition experience lifelog information manager 250 may be implemented by separate operations in a single server or in a plurality of servers, or may be implemented by a single operation. Moreover, the exhibition hall information manager 210, the visitor information manager 220, the viewing guide information generator 230, the transmitter 240, and the exhibition experience lifelog information manager 250 may be implemented as a plurality of physical devices or groups thereof, rather than as an individual physical device or a group of physical devices.

The exhibition hall information manager 210 may store and manage space information on an exhibition hall and location information on exhibition objects displayed at the exhibition hall.

In the exemplary embodiment, the exhibition hall information manager 210 may store a digital map of the space information on an exhibition hall and location information on exhibition objects displayed at the exhibition hall, and may manage the information stored as a digital map.

Further, the space information on an exhibition hall and the location information on exhibition objects displayed at the exhibition hall may be stored and managed as a list of information or as a database by the exhibition guide apparatus 200. Alternatively, the space information on an exhibition hall and the location information on exhibition objects displayed at the exhibition hall may be managed by a separate external system, and the exhibition guide apparatus 200 may receive or acquire the space information on an exhibition hall and the location information on exhibition objects displayed at the exhibition hall, and may manage the received information.

The visitor information manager 220 may store and manage visitor information that includes at least one or more of the following: identification information of visitors of an exhibition hall; avatar information of visitors, location information of visitors; and exhibition experience history information of visitors.

Here, the “visitor information” refers to information that may be used to specify visitors of a real exhibition hall and visitors of a virtual exhibition hall. For example, the visitor information may include at least one or more of the following: identification information of visitors of a real or virtual exhibition hall; avatar information of visitors, location information of visitors; and exhibition experience history information of visitors.

The “identification information of visitors” refers to information that may be used to differentiate visitors of a real exhibition hall from other visitors. For example, the identification information of visitors may include identifications (IDs) of visitors, identification numbers of mobile terminals carried by the visitors, and the like. In another example, in the case where a visitor carries a plurality of mobile terminals, an identification number of a mobile terminal that is representative among the mobile terminals may be used as the identification information of the visitor.

The “avatar information of visitors” refers to information that may be used to differentiate visitors of a virtual exhibition hall from other visitors. For example, the avatar information of visitors may include an initial location of a visitor avatar in a virtual exhibition hall, a final location thereof when the visitor finishes viewing exhibition objects, configuration information of the avatar, and the like. The “visitor avatar” may be a symbol, a mark, a graphic icon, and the like, but is not limited thereto, and may be any mark that may represent a visitor of a virtual exhibition hall.

The “location information of visitors” refers to a current location of a visitor in a real exhibition hall. In one exemplary embodiment, location information of a mobile terminal carried by a visitor may be determined to be location information of the visitor. In another exemplary embodiment, in the case where a visitor carries a plurality of mobile terminals, location information of a mobile terminal that is representative among the mobile terminals may be determined to be location information of the visitor.

The “exhibition experience history information” refers to information associated with a visitor's exhibition experience history. For example, a visitor's exhibition experience history may include information associated with a visitor's history of viewing exhibition objects at an exhibition of a single concept up to the current point in time. In another example, a visitor's exhibition experience history may include information associated with a visitor's history of viewing exhibition objects at multiple exhibitions of a similar concept up to the current point in time. In yet another exemplary embodiment, a visitor's exhibition experience history may include information associated with a visitor's history of viewing exhibition objects up to the current point in time.

In one exemplary embodiment, the visitor information manager 220 may store visitor information received from the mobile terminal 400 and may manage the stored information.

By using the space information of an exhibition hall, the location information of exhibition objects, and the visitor information, the viewing guide information generator 230 generates viewing guide information that includes one or more of the following: a visitor's exhibition experience history information, viewing status information on currently viewed exhibition objects, and viewing guide information on exhibition objects to be viewed in the future.

Here, the “viewing guide information” refers to information customized for each visitor of an exhibition hall. The viewing guide information may include one or more of the following: a visitor's exhibition experience history information, viewing status information on currently viewed exhibition objects, and viewing guide information on exhibition objects to be viewed in the future. For example, based on the viewing guide information, a visitor that visits again may check previously viewed exhibition objects, exhibition objects that are currently being viewed, and exhibition objects to be viewed in the future, rather than viewing exhibition objects all over again.

The “exhibition experience history information” refers to information associated with a visitor's history of viewing exhibition objects. For example, the exhibition experience history information may refer to information on previously viewed exhibition objects.

In one exemplary embodiment, the exhibition experience history information may refer to some information of previously viewed exhibition contents. The exhibition contents may refer to various types of information that may be obtained regarding exhibition objects. Alternatively, the exhibition contents may refer to various types of information that is associated with exhibition objects and that may be provided to visitors. For example, the exhibition contents may include images of how exhibition objects have been made. In another example, the exhibition contents may include the history of exhibition objects. In yet another example, the exhibition contents may include information on manufacturers of exhibition objects. In still another example, the exhibition contents may include information on online or offline stores selling exhibition objects that have been commercialized as products.

The “viewing status information on currently viewed exhibition objects” refers to information on exhibition objects that are currently being viewed. For example, the viewing status information on currently viewed exhibition objects may include location information on exhibition objects that are currently being viewed, explanation information on exhibition objects, and the like.

In one exemplary embodiment, the viewing status information on currently viewed exhibition objects may include some information of exhibition contents regarding exhibition objects that are currently being viewed.

The “viewing guide information on exhibition objects to be viewed in the future” refers to information on exhibition objects to be viewed in the future. For example, the viewing guide information on exhibition objects to be viewed in the future may include location information on exhibition objects to be viewed for the next time, information on a path of movement to exhibition objects from a current location, explanation information on exhibition objects, and the like.

In one exemplary embodiment, the viewing guide information on exhibition objects to be viewed in the future may include some information of exhibition contents that are provided regarding exhibition objects to be viewed in the future.

When a visitor views a specific exhibition object, the visitor may or may not see details about the exhibition object. Further, the visitor may obtain more detailed information on the exhibition object.

In one exemplary embodiment, the viewing guide information generator 230 may generate the viewing guide information by using basic viewing guide information that includes one or more of the following: space information on an exhibition hall, location information on exhibition objects, visitor information, viewing time of a specific exhibition object, information on whether details about a specific exhibition object have been viewed, information on currently viewed contents and information on contents to be viewed in the future based on the information on whether details about a specific exhibition object have been viewed.

Here, the information on whether details about a specific exhibition object have been viewed may indicate whether a visitor has seen details about a specific exhibition object. For example, in the case where a visitor viewed only the exterior of the specific exhibition object without seeing the explanation thereof, the information on whether details about a specific exhibition object have been viewed indicates that the visitor viewed only the exterior of the specific exhibition object when the visitor visits an exhibition hall again. Accordingly, based on the information on whether details about a specific exhibition object have been viewed, information on currently viewed contents may be explanation on the specific exhibition object.

The transmitter 240 transmits viewing guide information to either or both of the mobile terminal 400 and the exhibition display apparatus 300.

In one exemplary embodiment, the transmitter 240 transmits the viewing guide information to both of the mobile terminal 400 and the exhibition display apparatus 300. In this case, viewing guide information transmitted to the mobile terminal 400 and viewing guide information transmitted to the exhibition display apparatus 300 may be identical to each other.

The exhibition guide apparatus 200 may further include the exhibition experience lifelog information manager 250.

The exhibition experience lifelog information manager 250 stores exhibition experience lifelog information that indicates whether a visitor has seen details about exhibition objects based on a viewing result of exhibition objects. In this case, the transmitter 240 transmits the exhibition experience lifelog information to either or both of the mobile terminal 400 and the exhibition display apparatus 300.

Here, the “exhibition experience lifelog information” refers to information on whether details about a specific exhibition object have been viewed. In general, the lifelog literally refers to a personal record of everyday life, and in particular, the lifelog refers to a technique for recording and retrieving all information on everyday life experience in texts, photographs, videos, voices, and the like by using a digital device, and records obtained by using the technique. In the present disclosure, the exhibition experience lifelog information may indicate all the information generated by a visitor while viewing exhibition objects at an exhibition hall.

In one exemplary embodiment, the exhibition experience lifelog information may be included in the exhibition experience history information.

In another exemplary embodiment, the exhibition experience lifelog information manager 250 may store and manage exhibition experience lifelog information that indicates whether a visitor has seen details about exhibition objects based on a viewing result of exhibition objects, by comparing with the viewing guide information.

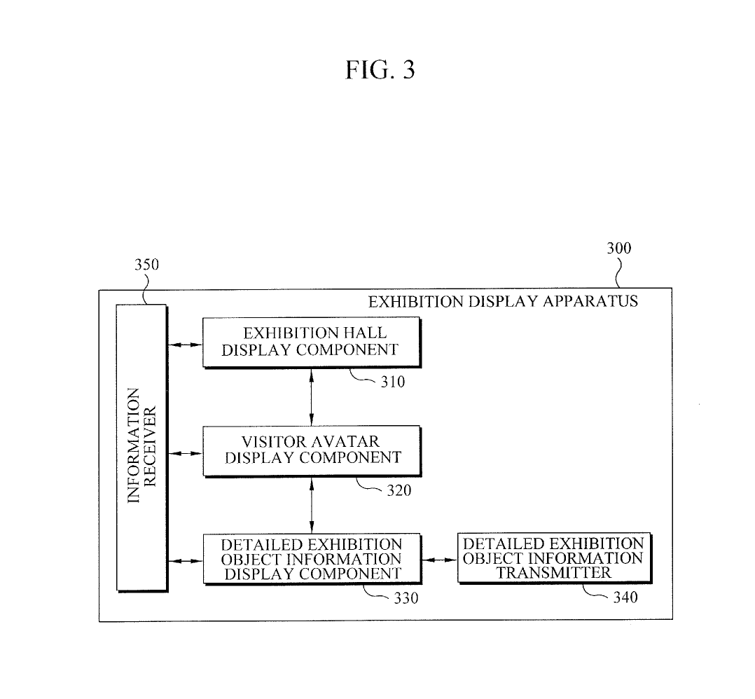

FIG. 3 is a block diagram schematically illustrating an exhibition display apparatus according to an exemplary embodiment.

Referring to FIG. 3, the exhibition display apparatus 300 includes an exhibition hall display component 310 and a visitor avatar display component 320. The exhibition display apparatus 300 may further includes a detailed exhibition object information display component 330 and a detailed exhibition object information transmitter 340.

The exhibition display apparatus 300 illustrated in FIG. 3 is merely illustrative, and the exhibition guide apparatus 300 may include only some of the modules illustrated in FIG. 3, and/or may further include other modules necessary for its operation. For example, the exhibition guide apparatus 300 may further include an information receiver 350 that receives information from the exhibition guide apparatus 200 and/or the mobile terminal 400.

Hereinafter, the exhibition hall display component 310, the visitor avatar display component 320, the detailed exhibition object information display component 330, and the detailed exhibition object information transmitter 340 are described as individual elements. However, the exhibition hall display component 310, the visitor avatar display component 320, the detailed exhibition object information display component 330, and the detailed exhibition object information transmitter 340 may be implemented in a single element, a single physical device, or a single module. For example, the exhibition hall display component 310, the visitor avatar display component 320, the detailed exhibition object information display component 330, and the detailed exhibition object information transmitter 340 may be implemented by separate operations or by a plurality of operations in a single server or in a plurality of servers, or may be implemented by a single operation. Moreover, the exhibition hall display component 310, the visitor avatar display component 320, the detailed exhibition object information display component 330, and the detailed exhibition object information transmitter 340 may be implemented as a plurality of physical devices or groups thereof, rather than as an individual physical device or a group of physical devices.

The exhibition hall display component 310 may display one or more of the following: space information on an exhibition hall that is received from the exhibition guide apparatus 200, location information on exhibition objects displayed at an exhibition hall, visitor information, viewing guide information and exhibition experience lifelog information.

In one exemplary embodiment, the exhibition hall display component 310 may display a virtual exhibition hall generated by using the space information on an exhibition hall and location information on exhibition objects displayed at an exhibition hall.

Here, the virtual exhibition hall may be metaverse. The metaverse is created by convergence of virtually enhanced physical reality and physically persistent virtual space. Thus, the virtual exhibition hall is the metaverse created by convergence of virtually enhanced physical exhibition space and physically persistent virtual space. Metaverse may contain other content beyond the physical exhibition space, as well as accommodates all the content contained in the physical exhibition space, and also can freely design the forms and configurations of content according to the purpose of exhibition.

In another exemplary embodiment, the exhibition hall display component 310 may display viewing status information on a real exhibition that is received from the exhibition guide apparatus 200, or may display viewing status information on the real exhibition that is generated by using images acquired from an image capturing apparatus.

In another exemplary embodiment, the exhibition hall display component 310 may display detailed information on an exhibition object that is being currently viewed according to viewing order information received from the exhibition guide apparatus 200 or the mobile terminal 400.

The visitor avatar display component 320 may display an avatar of a visitor that visits an exhibition hall displayed by the exhibition hall display component 310 according to avatar control information received from the mobile terminal 400.

The visitor avatar may see around a virtual exhibition hall displayed by the exhibition hall display component 310.

In one exemplary embodiment, the visitor avatar display component 320 may display a visitor avatar according to avatar control information received from the mobile terminal carried by a visitor. In another exemplary embodiment, the visitor avatar display component 320 may display a visitor avatar by a direct control of a visitor. In yet another exemplary embodiment, the visitor avatar display component 320 may display a visitor avatar according to avatar control information received from an avatar controller separately carried by a visitor.

In one exemplary embodiment, the visitor avatar display component 320 may display only the movement of a visitor avatar. Specifically, the visitor avatar display component 320 may display only a current location of a visitor avatar without displaying the path of movement in a virtual exhibition hall.

In another exemplary embodiment, the visitor avatar display component 320 may display a visitor avatar by tracking the path of movement of the visitor avatar.

The exhibition display apparatus 300 may further include a detailed exhibition object information display component 330 and a detailed exhibition object information transmitter 340.

The detailed exhibition object information display component 330 may display detailed information on exhibition objects according to avatar control information.

In one exemplary embodiment, the detailed exhibition object information display component 330 may display detailed information on an exhibition object by comparing location information of an exhibition object displayed by the exhibition hall display component 310 with location information of a visitor avatar controlled by avatar control information. Specifically, the detailed exhibition object information display component 330 compares location information of an exhibition object displayed by the exhibition hall display component 310 with location information of a visitor avatar controlled by avatar control information, and upon comparison, in the case where the exhibition object is positioned near a visitor avatar, the detailed exhibition object information display component 330 may display detailed information on the exhibition object.

In one exemplary embodiment, the detailed exhibition object display component 330 may display detailed information on an exhibition object in the case where a visitor avatar is positioned near the exhibition object displayed at an exhibition hall. In another exemplary embodiment, the detailed exhibition object information display component 330 may display detailed information on an exhibition object in the case where a visitor avatar is positioned within a specific distance from the exhibition object displayed at an exhibition hall. In yet another exemplary embodiment, the detailed exhibition object information display component 330 may display detailed information on an exhibition object by considering that a visitor avatar views the exhibition object when the visitor avatar is positioned near the exhibition object without moving for a determined period of time.

The detailed exhibition object information display component 330 may display detailed exhibition object information received from the exhibition guide apparatus 200. In this case, the detailed information on exhibition objects may be detailed information on exhibition objects according to location information of the mobile terminal 400. Specifically, the exhibition guide apparatus 200 compares location information of the mobile terminal with location information on exhibition objects, and the exhibition display apparatus 300 may receive and display detailed information on exhibition objects that is generated based on the comparison.

The detailed exhibition object information transmitter 340 may transmit detailed information on exhibition objects to the mobile terminal 400. Specifically, the detailed exhibition object information transmitter 340 may transmit, to the mobile terminal 400, detailed exhibition object information displayed by the detailed exhibition object display component 330. A visitor that carries the mobile terminal 400 may see detailed information on exhibition objects displayed by the exhibition display apparatus 300. Alternatively, a visitor that carries the mobile terminal 400 may see detailed exhibition object information transmitted from the detailed exhibition object information transmitter 340 to the mobile terminal 400.

In one exemplary embodiment, detailed information on exhibition objects that is displayed by the exhibition display apparatus 300 and detailed information on exhibition objects that is transmitted to the mobile terminal 400 may be identical to each other. In another exemplary embedment, detailed information on exhibition objects that is displayed by the exhibition display apparatus 300 and detailed information on exhibition objects that is transmitted to the mobile terminal 400 may be different from each other. For example, the detailed information on exhibition objects that is transmitted to the mobile terminal 400 may further include additional information on exhibition objects that is not displayed by the exhibition display apparatus 300.

The detailed exhibition object information transmitter 340 may transmit information to the mobile terminal 400 through a wireless network. For example, the wireless network may be a mobile communication network, a wireless Internet (WiFi), or the like.

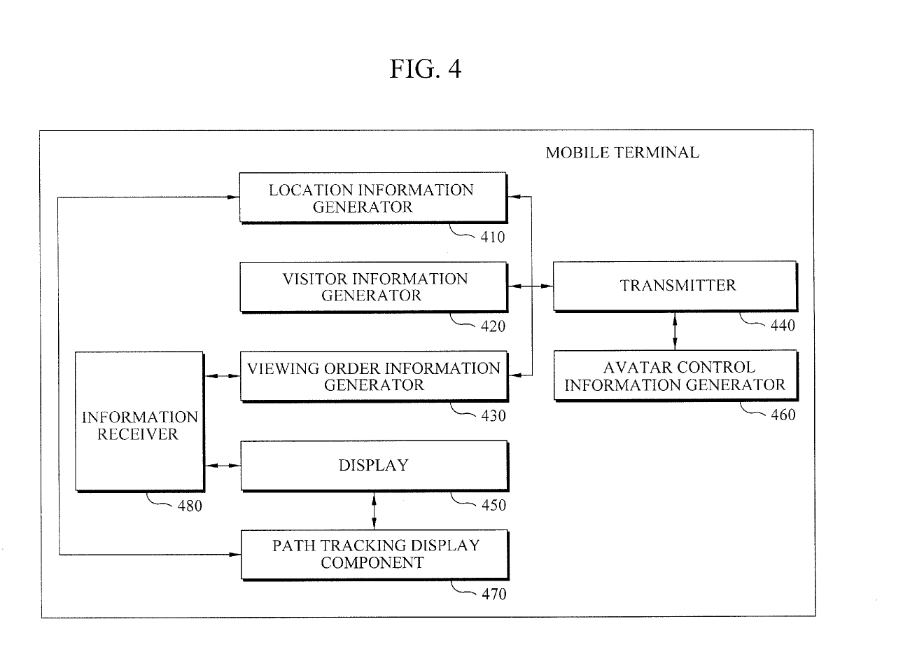

FIG. 4 is a block diagram schematically illustrating a mobile terminal according to an exemplary embodiment.

Referring to FIG. 4, the mobile terminal 400 may include a location information generator 410, a visitor information generator 420, a viewing order information generator 430, a transmitter 440, and a display 450. The mobile terminal 400 may further include an avatar control information generator 460. The mobile terminal 400 may further include a path tracking display component 470.

The mobile terminal 400 illustrated in FIG. 4 is merely illustrative, and the mobile terminal 400 may include only some of the modules illustrated in FIG. 4, and/or may further include other modules necessary for its operation. For example, the mobile terminal 400 may further include an information receiver 480 that receives information from the exhibition guide apparatus 200 and/or the exhibition display apparatus 300.

Hereinafter, the location information generator 410, the visitor information generator 420, the viewing order information generator 430, the transmitter 440, the display 450, the avatar control information generator 460, and the path tracking display component 470 are described as individual elements. However, the location information generator 410, the visitor information generator 420, the viewing order information generator 430, the transmitter 440, the display 450, the avatar control information generator 460, and the path tracking display component 470 may be implemented in a single element, a single physical device, or a single module. For example, the location information generator 410, the visitor information generator 420, the viewing order information generator 430, the transmitter 440, the display 450, the avatar control information generator 460, and the path tracking display component 470 may be implemented by separate operations or by a plurality of operations in a single server or in a plurality of servers, or may be implemented by a single operation. Moreover, the location information generator 410, the visitor information generator 420, the viewing order information generator 430, the transmitter 440, the display 450, the avatar control information generator 460, and the path tracking display component 470 may be implemented as a plurality of physical devices or groups thereof, rather than as an individual physical device or a group of physical device.

The location information generator 410 may measure a current location of a mobile terminal to generate location information of the mobile terminal.

While a visitor moves around a real exhibition hall carrying a mobile terminal, the mobile terminal 400 may measure a current location by using an indoor positioning technique. The mobile terminal 40 transmits the measured current location to the exhibition guide apparatus 200. There is no limitation on a method of calculating the current location of the mobile terminal 400, and any one known indoor positioning algorithm may be used to calculate a current location of the mobile terminal 400.

The indoor positioning method may be separated into a triangulation method, a proximity method, and a location fingerprint method depending on wireless communication techniques. The triangulation calculates a location by measuring distances from three different points. The proximity includes: a method of monitoring wireless access points to see whether an object, of which location is tracked, is within an available range of one or a plurality of access points in a wireless cell network; and a method of measuring a location by using an automatic identification system or by importing tag information. The location fingerprint measures a location by selecting several locations at random in a service area and by using signal strength information collected at the selected locations.

The location information generator 410 may measure a location of the mobile terminal 400 by using a signal received from a wireless signal generator. The wireless signal generator is a device that transmits, to the mobile terminal 400, a signal required to measure a location. For example, the wireless signal generator may be a Bluetooth, Beacon that generates a wireless signal according to wireless communication standards such as (WiFi), an Access Point (AP), and the like.

In one exemplary embodiment, a wireless signal may include signal strength information, identification information of wireless signal generators, and the like.

In another exemplary embodiment, the location information generator 410 may generate location information of a visitor by measuring the location of the visitor that carries a mobile terminal. In this case, the transmitter 440 may transmit location information of a visitor, visitor information, and viewing order information to either or both of the exhibition guide apparatus 200 and the exhibition display apparatus 300.

The visitor information generator 420 may generate visitor information that includes one or more of the following: identification information of visitors that visit an exhibition hall, avatar information of visitors, location information of visitors, and exhibition experience history information of visitors.

Here, the “visitor information” refers to information that may specify visitors of a real exhibition hall and visitors of a virtual exhibition hall. For example, the visitor information may include one or more of identification information of visitors that visit a real exhibition hall or a virtual exhibition hall, avatar information of visitors, location information of visitors, and exhibition experience history information of visitors. Other visitor information is described above with reference to FIG. 2, such that detailed description thereof will be omitted.

The viewing order information generator 430 may generate viewing order information according to plans for viewing exhibition objects selected by a visitor based on viewing guide information that includes one or more of exhibition experience history information, viewing status information on currently viewed exhibition objects, and viewing guide information of exhibition objects to be viewed in the future, in which the exhibition experience history information, the viewing status information, and the viewing guide information are received from the exhibition guide apparatus.

For example, a visitor may determine a viewing order according to plans for viewing exhibition objects to be viewed in the future based on the viewing guide information. The viewing order information generator 430 may generate viewing order information according to the determined plans for viewing exhibition objects.

In one exemplary embodiment, the viewing order information generator 430 may generate viewing order information based on the viewing guide information of exhibition objects to be viewed in the future among viewing guide information received from the exhibition guide apparatus 200.

In another exemplary embodiment, the viewing order information generator 430 may generate viewing order information based on exhibition experience history information, viewing status information on currently viewed exhibition objects, and viewing guide information of exhibition objects to be viewed in the future, among viewing guide information received from the exhibition guide apparatus. For example, if a visitor wishes to view an exhibition object again after seeing the object, the visitor may determine a viewing order according to viewing plans.

The transmitter 440 may transmit location information of a mobile terminal, visitor information, and viewing order information to either or both of the exhibition guide apparatus 200 and the exhibition display apparatus 300.

The transmitter 440 may transmit the information to the viewing guide information 200 and the exhibition display apparatus 300 through a wireless network. For example, the wireless network may be a mobile communication network, a wireless Internet (WiFi), and the like.

The display 350 may display, on a screen of the mobile terminal, visitor information and viewing guide information acquired through a user interface or from the exhibition guide apparatus 200.

In one exemplary embodiment, the visitor information and the viewing guide information displayed by the exhibition display apparatus 300 and the visitor information and the viewing guide information displayed by the mobile terminal 400 may be identical to each other.

In another exemplary embodiment, the display 450 may display, on a screen of the mobile terminal 400, detailed information on exhibition objects displayed by the detailed exhibition object information display component 330 of the exhibition display apparatus 300. For example, a visitor carrying the mobile terminal 400 may see the detailed information on exhibition objects displayed by the exhibition display apparatus 300. Alternatively, a visitor carrying the mobile terminal 400 may see the detailed information on exhibition objects displayed by the display 450 on a screen of the mobile terminal 400.

The mobile terminal 400 may further include an avatar control information generator 460.

The avatar control information generator 460 may generate avatar control information to control visitor avatar information displayed on the exhibition display apparatus 300.

The “avatar control information” refers to information used to control movement of a visitor avatar in an exhibition hall displayed on the exhibition display apparatus 300. For example, the avatar control information generator 460 may generate information to control a visitor icon to move from side to side or up and down in an exhibition hall displayed on the exhibition display apparatus 300. In another example, the avatar control information generator 460 may generate control information so that a visitor avatar appears in an exhibition hall displayed on the exhibition display apparatus 300, or the visitor avatar leaves an exhibition hall displayed on the exhibition display apparatus 300 after viewing exhibition objects.

In this case, the transmitter 440 may transmit the avatar control information to the exhibition display apparatus 300. The transmitter 440 may transmit the information to the exhibition display apparatus 300 through a wireless network. For example, the wireless network may be a mobile communication network or wireless Internet (WiFi).

The mobile terminal 400 may further include a path tracking display component 470.

In the case where location information of a mobile terminal is changed, the path tracking display component 470 may display, on a screen of the mobile terminal, avatar tracking information that includes a path of movement from a location before change to a location after change.

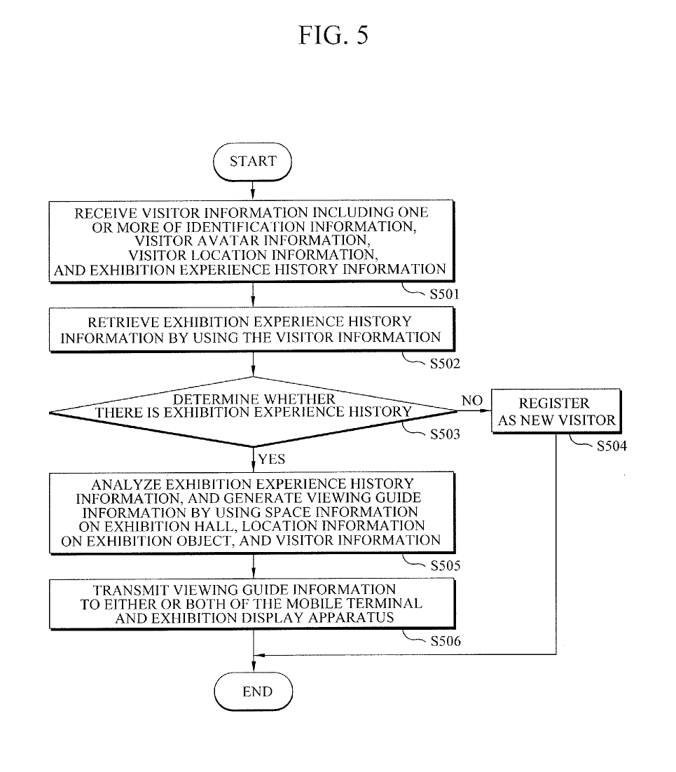

FIG. 5 is a flowchart illustrating an exhibition guide method of an exhibition guide apparatus according to an exemplary embodiment.

The operations to be described below, including the exemplary embodiments of the present disclosure, may be implemented in various manners. The exhibition guide method illustrated in FIGS. 5 to 8 may be an exhibition guide method performed by using the exhibition guide apparatus illustrated in FIG. 2 or an electronic device including the exhibition guide apparatus. Accordingly, the exhibition guide method will be briefly described to avoid unnecessary repetition, and matters not described herein are described above with reference to FIGS. 1 to 4.

Referring to FIG. 5, the exhibition guide method, which is performed by using the exhibition guide apparatus 200, the exhibition display apparatus 300, and the mobile terminal 400, includes: receiving from the mobile terminal 400 visitor information that includes one or more of identification information, visitor avatar information, visitor location information, and exhibition experience history information in S501; retrieving the exhibition experience history information by using the visitor information in S502; determining in S503 whether there is an exhibition experience history upon retrieval, if there is no exhibition experience history, registering a visitor as a new visitor in S504, and if there is an exhibition experience history, analyzing the exhibition experience history information and generating viewing guide information that includes one or more of exhibition experience history information, viewing status information on currently viewed exhibition objects, and viewing guide information on exhibition objects to be viewed in the future by using space information on an exhibition hall, location information on exhibition objects, and visitor information in S505; and transmitting the viewing guide information to either or both of the mobile terminal and exhibition display apparatus in S506.

First, visitor information that includes one or more of identification information, visitor avatar information, visitor location information, and exhibition experience history information is received from the mobile terminal 400 in S501.

Subsequently, the exhibition experience history information is retrieved by using the visitor information in S502.

Upon retrieval, it is determined in S503 whether there is an exhibition experience history, and if there is no exhibition experience history, a visitor is registered as a new visitor in S504, and if there is an exhibition experience history, the exhibition experience history information is analyzed, and viewing guide information that includes one or more of exhibition experience history information, viewing status information on currently viewed exhibition objects, and viewing guide information on exhibition objects to be viewed in the future is generated by using space information on an exhibition hall, location information on exhibition objects, and visitor information in S505.

In the exemplary embodiment, the generating of viewing guide information in S505 may include generating viewing guide information by using basic viewing guide information that includes one or more of space information on an exhibition hall, location information on exhibition objects, visitor information, viewing time of a specific exhibition object, information on whether details about a specific exhibition object have been viewed, information on currently viewed contents and information on contents to be viewed in the future based on the information on whether details about a specific exhibition object have been viewed.

Then, the viewing guide information is transmitted to either or both of the mobile terminal and the exhibition display apparatus in S506.

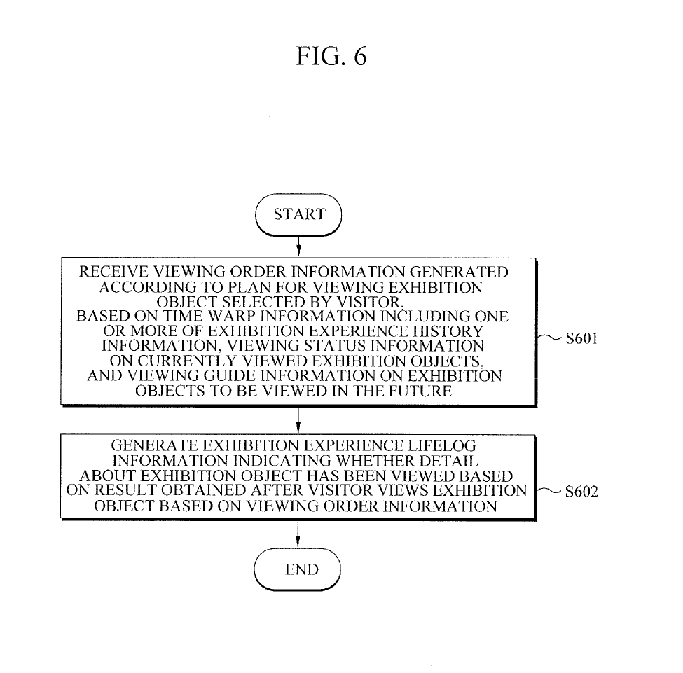

FIG. 6 is a flowchart illustrating an exhibition guide method of an exhibition guide apparatus according to another exemplary embodiment.

Referring to FIG. 6, the exhibition guide method may include, in addition to the exhibition guide method illustrated in FIG. 5: receiving viewing order information generated according to plans for viewing exhibition objects selected by a visitor in S601; and generating exhibition experience lifelog information that indicates whether details about exhibition objects have been viewed based on results obtained after a visitor has viewed exhibition objects according to the generated viewing order information in S602, based on the viewing guide information that includes one or more of exhibition experience history information, viewing status information on currently viewed exhibition objects, and viewing guide information on exhibition objects to be viewed in the future.

First, based on the viewing guide information that includes one or more of exhibition experience history information, viewing status information on currently viewed exhibition objects, and viewing guide information on exhibition objects to be viewed in the future, viewing order information generated according to plans for viewing exhibition objects selected by a visitor is received in S601.

Then, exhibition experience lifelog information is generated in S602, in which the exhibition experience lifelog information indicates whether details about exhibition objects have been viewed based on results obtained after a visitor has viewed exhibition objects according to the generated viewing order information.

In the exemplary embodiment, the generating of the exhibition experience lifelog information in S602 may include comparing with the viewing guide information to generate exhibition experience lifelog information that indicates whether details about exhibition objects have been viewed based on results obtained after a visitor has viewed exhibition objects.

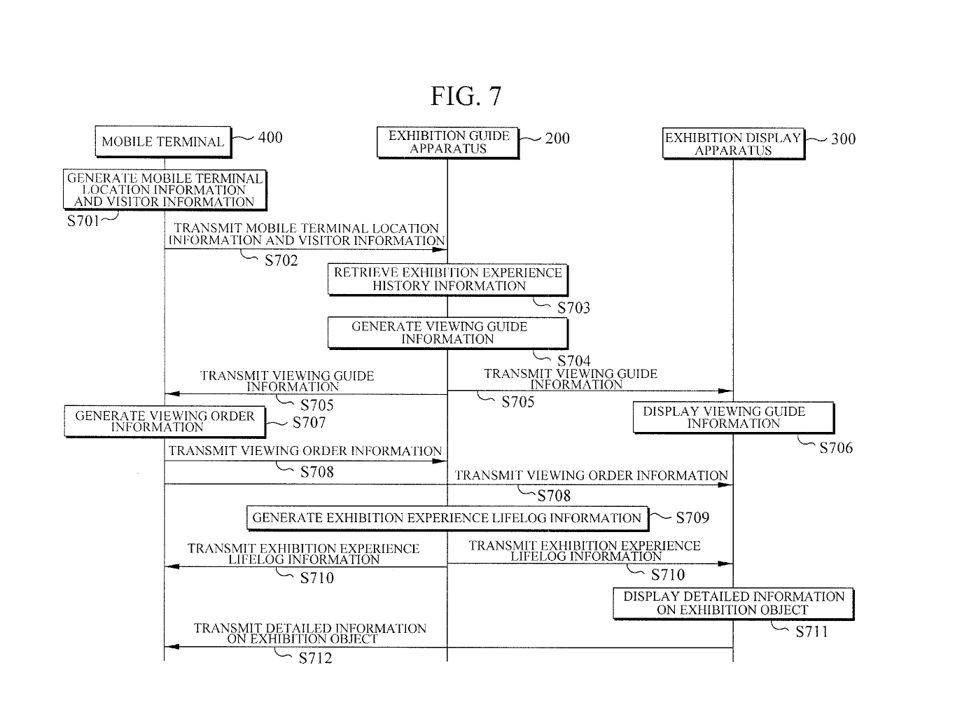

FIG. 7 is a flowchart illustrating an exhibition guide method in an exhibition guide system according to an exemplary embodiment.

The operations to be described below, including the exemplary embodiments of the present disclosure, may be implemented in various manners. The exhibition guide method illustrated in FIG. 7 may be an exhibition guide method performed by using the exhibition guide apparatus 200 illustrated in FIG. 2, the exhibition display apparatus 300 illustrated in FIG. 3, and the mobile terminal 400 illustrated in FIG. 4, or an electronic device including the same. Accordingly, the exhibition guide method will be briefly described to avoid unnecessary repetition, and matters not described herein are described above with reference to FIGS. 1 to 4.

Referring to FIG. 7, the mobile terminal 400 generates mobile terminal location information and visitor information in S701, and transmits the generated mobile terminal location information and visitor information to the exhibition guide apparatus 200 in S702.

Then, the exhibition guide apparatus 200 retrieves exhibition experience history information by using visitor information in S703. If a retrieval result shows that there is an exhibition experience history, the exhibition guide apparatus 300 generates viewing guide information in S704. Specifically, if a retrieval result shows that there is an exhibition experience history, exhibition experience history information of a visitor is analyzed, and viewing guide information that includes one or more exhibition experience history information, viewing status information on currently viewed exhibition objects, and viewing guide information on exhibition objects to be viewed in the future is generated by using space information on an exhibition hall, location information on exhibition objects, and visitor information.

Subsequently, the exhibition guide apparatus 200 transmits the generated viewing guide information to either or both of the mobile terminal 400 and the exhibition display apparatus 300 in S705.

Next, the exhibition display apparatus 300 displays the viewing guide information in S706. In the exemplary embodiment, the exhibition display apparatus 300 may display one or more of space information on an exhibition hall, location information on exhibition objects, and visitor information, the viewing guide information, and the exhibition experience lifelog information.

Then, the mobile terminal 400 generates viewing order information in S707, and transmits the generated viewing order information to either or both of the exhibition guide apparatus 200 and the exhibition display apparatus 300 in S708.

Subsequently, the exhibition guide apparatus 200 generates viewing lifelog information in S709, and transmits the generated viewing lifelog information to either or both of the mobile terminal 400 and the exhibition display apparatus 300 in S710.

The exhibition display apparatus 300 displays detailed information on exhibition objects in S711 and transmits the detailed information on exhibition objects to the mobile terminal 400 in S712.

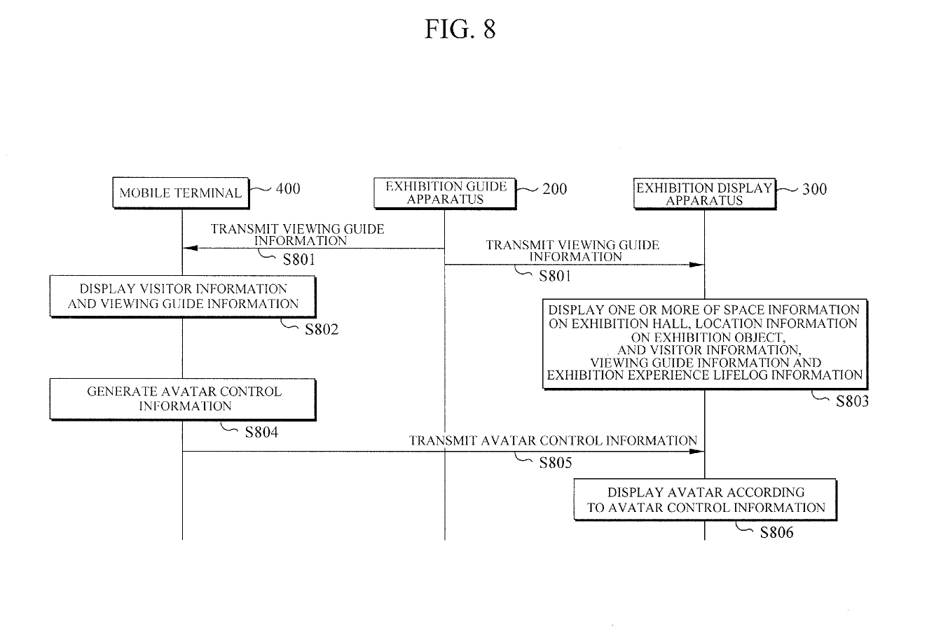

FIG. 8 is a flowchart illustrating an exhibition guide method in an exhibition guide system according to another exemplary embodiment. FIG. 8 illustrates another exemplary embodiment showing an operation after the generating of viewing guide information in S705.

Referring to FIG. 8, the exhibition guide apparatus 200 transmits the viewing guide information to either or both of the mobile terminal 400 and the exhibition display apparatus 300 in S801.

Then, the mobile terminal 400 displays visitor information and the viewing guide information in S802. The exhibition display apparatus 300 displays one or more of space information on an exhibition hall, location information on exhibition objects, and visitor information, viewing guide information, and exhibition experience lifelog information in S803.

Next, the mobile terminal 400 generates avatar control information in S804, and transmits the generated avatar control information to the exhibition display apparatus 300 in S805.

Subsequently, the exhibition display apparatus 300 displays an avatar according to the received avatar control information in S806.

As described above, visitors may efficiently view exhibition objects displayed at an exhibition hall by considering proximity of experience information.

Further, in the exemplary embodiments of the present disclosure, visitors may be provided with viewing guide information customized for each visitor by combining a visitor's exhibition experience information on the past, present, and future visits.

Moreover, in the exemplary embodiments of the present disclosure, visitors may see exhibition objects according to their intentions.

The exhibition guide methods and/or operations using the exhibition guide apparatus, the exhibition display apparatus, and the mobile terminal described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The program instructions of the medium may be designed or configured specially for the present invention, or may be used well-known to those who are skilled in the art. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. The medium may be a transmission medium such as an optical fiber, a metal wire and a waveguide, which includes carrier waves that transmits signals for defining program instructions or data structures. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An exhibition guide apparatus that communicates with an exhibition display apparatus and a mobile terminal, the exhibition guide apparatus comprising:
an exhibition hall information manager configured to store and manage space information on an exhibition hall and location information on exhibition objects displayed at the exhibition hall;
a visitor information manager configured to store and manage visitor information that includes one or more of identification information, visitor avatar information, visitor location information, and exhibition experience history information;
a viewing guide information generator configured to generate viewing guide information that includes one or more of exhibition experience history information, viewing status information on currently viewed exhibition objects, and viewing guide information on exhibition objects to be viewed in the future, by using the space information on the exhibition hall and the location information on exhibition objects, and the visitor information; and
a transmitter configured to transmit the viewing guide information to either or both of the mobile terminal and the exhibition display apparatus.

2. The apparatus of claim 1, wherein the visitor information manager stores and manages visitor information received from the mobile terminal.

3. The apparatus of claim 1, wherein the viewing guide information generator generates the exhibition guide information by using basic viewing guide information that includes one or more of the space information on the exhibition hall, the location information on exhibition objects, the visitor information, viewing time of a specific exhibition object, information on whether details about the specific exhibition object have been viewed, information on currently viewed contents and information on contents to be viewed in the future based on the information on whether details about the specific exhibition object have been viewed.

4. The apparatus of claim 1, wherein:
the exhibition guide apparatus further comprises an exhibition experience lifelog information manager configured to store and manage exhibition experience lifelog information that indicates whether details about the specific exhibition object have been viewed; and
the transmitter transmits the exhibition experience lifelog information to either or both of the mobile terminal and the exhibition display apparatus.

5. The apparatus of claim 4, wherein the exhibition experience lifelog information manager stores and manages the exhibition experience lifelog information that indicates whether a visitor has seen details about exhibition objects based on a viewing result of exhibition objects, by comparing with the viewing guide information.

6. An exhibition display apparatus that communicates with an exhibition guide apparatus and a mobile terminal, the exhibition display apparatus comprising:
an exhibition hall display component configured to display space information on an exhibition hall that is received from the exhibition guide apparatus, location information on exhibition objects displayed at the exhibition hall, visitor information, viewing guide information, and exhibition experience lifelog information; and
a visitor avatar display component configured to display an avatar of a visitor in the exhibition hall displayed by the exhibition hall display component according to avatar control information received from the mobile terminal.

7. The apparatus of claim 6, wherein the exhibition hall display component displays a virtual exhibition hall generated by using the space information on the exhibition hall and the location information on exhibition objects displayed at the exhibition hall.

8. The apparatus of claim 6, wherein the exhibition hall display component displays viewing status information on the real exhibition that is received from the exhibition guide apparatus, or viewing displays status information on the real exhibition hall that is generated by using images acquired from an image capturing apparatus.

9. The apparatus of claim 6, wherein the exhibition hall display component displays detailed information on an exhibition object that is being currently viewed according to viewing order information received from the exhibition guide apparatus or the mobile terminal.

10. The apparatus of claim 6, wherein the exhibition display apparatus further comprises:
a detailed exhibition object information display component configured to display detailed information on exhibition objects according to the avatar control information; and
a detailed exhibition object information transmitter configured to transmit the detailed exhibition object information to the mobile terminal.

11. The apparatus of claim 10, wherein the detailed exhibition object information display component displays detailed information on a specific exhibition object by comparing location information of the specific exhibition object displayed by the exhibition hall display component with location information of a visitor avatar controlled by the avatar control information.

12. A mobile terminal that communicates with an exhibition guide apparatus and an exhibition display apparatus, the mobile terminal comprising:
a location information generator configured to generate location information of the mobile terminal by measuring a current location of the mobile terminal;
a visitor information generator configured to generate visitor information that includes one or more of identification information, visitor avatar information, visitor location information, and exhibition experience history information;
a viewing order information generator configured to generate viewing order information according to plans for viewing exhibition objects selected by a visitor based on viewing guide information that includes one or more of exhibition experience history information, viewing status information of currently viewed exhibition objects, and viewing guide information of exhibition objects to be viewed in the future;
a transmitter configured to transmit the location information of the mobile terminal, the visitor information, and the viewing order information to either or both of the exhibition guide apparatus and the exhibition display apparatus; and
a display configured to display, on a screen of the mobile terminal, the visitor information and the viewing guide information acquired through a user interface of the mobile terminal or from the exhibition guide apparatus.

13. The mobile terminal of claim 12, wherein the location information generator measures a location of the mobile terminal by using a signal received from a wireless signal generator.

14. The mobile terminal of claim 12, wherein:
the location information generator generates location information of a visitor by measuring a location of the visitor that carries the mobile terminal; and
the transmitter transmits the location information of the visitor, the visitor information, and the viewing order information to either or both of the exhibition guide apparatus and the exhibition display apparatus.

15. The mobile terminal of claim 12, wherein:
the mobile terminal further comprises an avatar control information generator configured to generate avatar control information to control avatar information of the visitor displayed by the exhibition display apparatus; and
the transmitter transmits the avatar control information to the exhibition display apparatus.

16. The mobile terminal of claim 12, further comprising a path tracking display component, which in response to change in a location of the mobile terminal, is configured to display avatar tracking information that includes a path of movement from a location before the change to a location after the change.

17. An exhibition guide method performed by using an exhibition guide apparatus, an exhibition display apparatus, and a mobile terminal, the method comprising:
receiving, from the mobile terminal, visitor information that includes one or more of identification information, visitor avatar information, visitor location information, and exhibition experience history information of a visitor;
retrieving the exhibition experience history information by using the visitor information;
determining whether there is an exhibition experience history upon retrieval, and in response to a determination there is no exhibition experience history, registering the visitor as a new visitor, and in response to a determination that there is an exhibition experience history, analyzing the exhibition experience history information and generating viewing guide information that includes one or more of exhibition experience history information, viewing status information on currently viewed exhibition objects, and viewing guide information on exhibition objects to be viewed in the future by using space information on the exhibition hall, location information on exhibition objects, and the visitor information; and
transmitting the viewing guide information to either or both of the mobile terminal and exhibition display apparatus.

18. The method of claim 17, the generating of the viewing guide information comprises generating the exhibition guide information by using basic viewing guide information that includes one or more of the space information on the exhibition hall, the location information on exhibition objects, the visitor information, viewing time of a specific exhibition object, information on whether details about the specific exhibition object have been viewed, information on currently viewed contents and information on contents to be viewed in the future based on the information on whether details about the specific exhibition object have been viewed.

19. The method of claim 17, further comprising:
receiving viewing order information generated according to plans for viewing exhibition objects selected by a visitor, based on the viewing guide information that includes one or more of exhibition experience history information, viewing status information on currently viewed exhibition objects, and viewing guide information on exhibition objects to be viewed in the future; and
generating exhibition experience lifelog information that indicates whether details about the specific exhibition object have been viewed based on results obtained after a visitor has viewed exhibition objects according to the generated viewing order information.

20. The method of claim 19, wherein the generating of the exhibition experience lifelog information comprises comparing with the viewing guide information to generate the exhibition experience lifelog information that indicates whether details about exhibition objects have been viewed.
